(19) United States
(12) Patent Application Publication
(10) Pub. No.: US 2010/0189976 A1
(43) Pub. Date: Jul. 29, 2010

(54) Multi-Layer Composite Fabric

(76) Inventor: Dennis Snyder, New Philadelphia, OH (US)

Correspondence Address: BUCKINGHAM, DOOLITTLE & BURROUGHS, LLP, 3800 EMBASSY PARKWAY, SUITE 300, AKRON, OH, 44333-8332, US

(21) Appl. No.: 12/696,290

(22) Filed: Jan. 29, 2010

Related U.S. Application Data
(60) Provisional application No. 61/148,211, filed on Jan. 29, 2009.

(51) Int. Cl. B32B 7/02; B32B 27/00; D03D 11/00

(52) U.S. Cl. 428/215; 442/1; 156/60; 428/221

(57) ABSTRACT

An architecture is presented for a composite fabric. The composite fabric comprises a scrim sheet and an underlying adhesive layer. The scrim sheet is combined with an adhesive as a set and then laminated with the adhesive layer. A top sheet, white polyvinyl chloride (PVC) layer overlays a second side of the scrim sheet. An opaque layer underlies a first side of the scrim sheet, wherein the adhesive layer bonds the opaque layer to the scrim sheet. Additionally, an abrasion resistant film layer underlies the opaque layer. Further, a bottom sheet, white layer underlies the abrasion resistant film layer. An adhesive is then applied to both sides of the abrasion resistant film layer to bond the abrasion resistant film layer to the PVC layers. Alternatively, ripstop or closely woven fabric can be applied to both side of the opaque layer with thermoplastic top and bottom layers.

### CROSS-REFERENCE

This application claims priority from Provisional Patent Application Ser. No. 61/148,211 filed Jan. 29, 2009.

### BACKGROUND

Protective multi-layer composite fabrics find use as flexible covers or barriers in a wide variety of applications. For example, a multi-layer composite fabric could be used in a tent or other protective structure, used to create an infrared shield, used to create a dark room, or used in garments which are manufactured to act as a barrier for chemical and biological contaminants, such as nerve gas and infectious microorganisms from a surrounding atmosphere.

Generally, multi-layer composite fabrics need to be lightweight and abrasion resistant, especially when utilized in tents or other protective structures. Tents and other protective structures are typically expected to protect their occupants from exposure to elemental forces of wind, rain, sunlight and the pelting of snow, sand and other windblown particulates. High-performance tents and protective fabrics may be expected to provide their occupants with a measure of protection from extreme exposure to frigid polar climates, searing deserts and gusty mountaintops. A tent must provide shelter while being collapsible, easily packed and transported. Further, a tent must be constructed to resist wear and tear during repeated stresses of unpacking and repacking. Accordingly, a tent is generally expected to be collapsible, lightweight, easily transported by one person, and abrasion resistant. Thus, a multi-layer composite fabric utilized in the construction of a tent needs to be lightweight for ease of transportation yet abrasion resistant to protect against pinholes and other degradation of the fabric.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a composite fabric. The composite fabric comprises a scrim sheet and an underlying adhesive layer. The scrim sheet is a web-like fabric layer that is strong and flexible. The scrim sheet is combined with an adhesive as a set and then laminated with the adhesive layer. Further, a top sheet thermoplastic layer overlays a second side of the scrim sheet. The top sheet thermoplastic layer is typically a white, flexible polyvinyl chloride (PVC) layer.

An additional thermoplastic layer underlies a first side of the scrim sheet, wherein the adhesive layer bonds the thermoplastic layer to the scrim sheet. The additional thermoplastic layer is typically a blackout, flexible PVC layer. Additionally, an abrasion resistant film layer underlies the additional thermoplastic layer. Further, a bottom sheet thermoplastic layer underlies the abrasion resistant film layer. The bottom sheet thermoplastic layer is typically a white, flexible PVC layer. Further, an adhesive is applied to both sides of the abrasion resistant film layer to bond the abrasion resistant film layer to the thermoplastic layers.

In another aspect, the blackout, flexible PVC layer is removed from the composite fabric. In this construction, the abrasion resistant film layer underlies the adhesive layer and not a blackout, flexible PVC layer. The bottom sheet thermoplastic layer underlies the abrasion resistant film layer and an adhesive is applied to both sides of the abrasion resistant film layer to bond the abrasion resistant film layer to the bottom sheet thermoplastic layer.

In another aspect, the abrasion resistant film layer is positioned on the second side of the scrim sheet, with the blackout, flexible PVC layer also being positioned on the second side of the scrim sheet. Furthermore, the abrasion resistant film layer could be positioned on both sides of the scrim sheet, or as two abrasion resistant film layers, one layer on top of the other layer for extra resistance to abrasion.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a sectional view of a composite fabric.

FIG. 2 illustrates an exploded view of the composite fabric.

FIG. 3 illustrates an exploded view of the composite fabric wherein a black-out layer polyvinyl chloride (PVC) is removed.

FIG. 4 illustrates an exploded view of the composite fabric wherein the abrasion resistant film layer is positioned on the opposite side of the scrim sheet.

FIG. 5 illustrates an exploded view of the composite fabric wherein the abrasion resistant film layer is positioned on both sides of the scrim sheet.

FIG. 6 illustrates an exploded view of the composite fabric wherein there are two abrasion resistant film layers positioned on top of one another.

FIG. 7 illustrates a method of fabricating the composite fabric.

FIG. 8 illustrates an exploded view of an embodiment of the composite fabric.

FIG. 9 illustrates an exploded view of another embodiment of the composite fabric.

FIG. 10 illustrates an exploded view of another embodiment of the composite fabric.

FIG. 11 illustrates an exploded view of another embodiment of the composite fabric.

FIG. 12 illustrates an exploded view of another embodiment of the composite fabric.

FIG. 13 illustrates an exploded view of another embodiment of the composite fabric.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Typically, multi-layer composite fabrics need to be lightweight and abrasion resistant, especially when utilized in tents or other protective structures. Tents and other protective structures are typically expected to protect their occupants from exposure to elemental forces. Specifically, a tent must provide shelter while being collapsible, easily packed and transported. Further, a tent must be constructed to resist wear and tear during repeated stresses of unpacking and repacking. In the course of handling, erecting, stretching and cleaning thermoplastic coverings for tents and other structures, the opaque covering can become damaged allowing light to come through. Since the rest of the structure is dark this pin hole or larger blemish shows up and makes the tent or other structure less desirable. Thus, a multi-layer composite fabric utilized in the construction of a tent needs to be lightweight for ease of transportation yet abrasion resistant to protect against pinholes and other degradation of the fabric.

Accordingly, the multi-layer composite fabric as disclosed is lightweight and abrasion resistant when utilized in a tent or other protective structure. The composite fabric comprises a scrim sheet and an overlaying adhesive layer. Further, an opaque polyvinyl chloride (PVC) layer overlays a first side of the scrim sheet, wherein the adhesive bonds the opaque PVC layer to the scrim sheet. Additionally, an abrasion resistant film layer overlays the opaque PVC layer and a bottom sheet PVC layer overlays the abrasion resistant film layer. The addition of the abrasion resistant film layer between the opaque PVC layer and the bottom sheet PVC layer improves the thermal seal qualities of the abrasion resistant film layer. Typically, abrasion resistant film exhibits poor thermal seal qualities, however positioning the abrasion resistant film layer between two PVC layers improves the thermal seal qualities of the abrasion resistant film layer and acts to provide increased abrasion resistance to the composite fabric. Thus, the abrasion resistant film layer is positioned on the inside of the multi-layer composite fabric while an easily heat-sealable colored layer is positioned on the outside top and bottom of the multi-layer composite fabric. This allows fabrication of the multi-layer composite fabric using conventional thermoplastic methods such as radio frequency (RF) welding, hot wedge welding, hot air welding and hot wire welding without buffing off a coating that does not heat seal as easily as thermoplastic elastomers (TPE), thermoplastic olefins (TPO) or flexible PVC, and allows protection of the softer flexible opaque layer with a hard film such as Mylar®, high-density polyethylene (HDPE), Tedlar®, acrylic or nylon, or a closely woven fabric. Accordingly, the opaque layer can be protected from abrasion and puncture, and the hard film layer also adds chemical permeation protection to the multi-layer composite fabric.

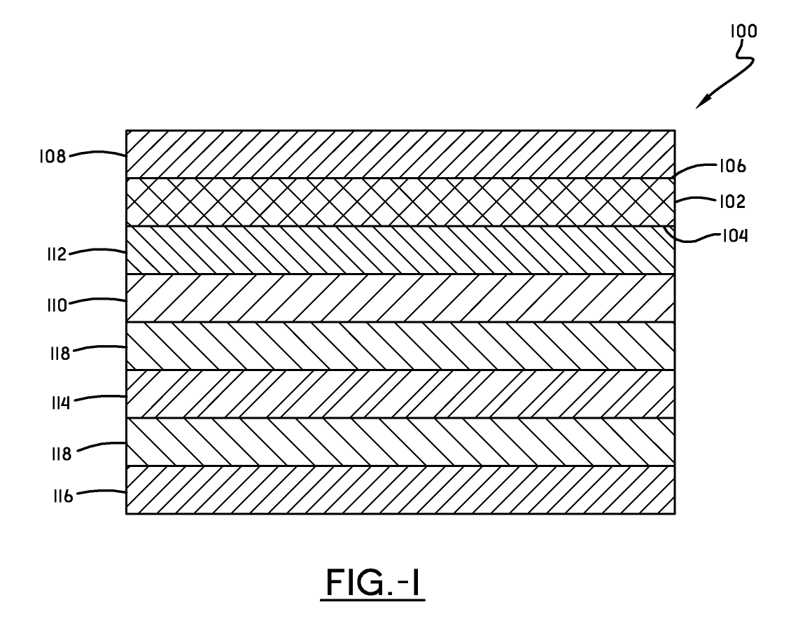

Referring initially to the drawings, FIG. 1 illustrates a composite fabric 100. The composite fabric 100 comprises a scrim sheet 102 and an adhesive layer 112. The scrim sheet 102 is a web-like fabric layer that is strong and flexible. The scrim sheet 102 can be from 0.5-10 oz. The scrim sheet 102 is combined with an adhesive as a set (not shown) and then laminated with the underlying adhesive layer 112. Specifically, the scrim sheet 102 is dipped in an adhesive, such as a plastisol, wherein the adhesive penetrates the scrim sheet 102 and forms a set. The scrim sheet 102 and set is then laminated with the adhesive layer 112. The adhesive layer 112 can be from 0.1-5 mils. thick. Typically, the adhesive layer 112 is also a plastisol. Further, the scrim sheet 102 can have a yarn count of 9×9 or 18×14, or even 18×18, typically the yarn count is 18×14. The size of the yarn is 500 by 500 denier yarn for 18×18, 840 by 1,000 denier yarn for 18×14 or 1,000 by 1,000 denier yarn for 9×9. Additionally, the yarn for the fabric layer is typically plain woven or weft inserted. Typically, the fabric sheet is black or opaque and is laminated with a black adhesive or opaque adhesive to offer more protection against pinholes.

Furthermore, the scrim sheet 102 has a first side 104 and a second side 106, wherein a top sheet thermoplastic layer 108 overlays the second side 106 of the scrim sheet 102. The top sheet thermoplastic layer 108 can be 2-20 mils. thick. The top sheet thermoplastic layer 108 is typically a white, flexible polyvinyl chloride (PVC) layer, but can be any thermoplastic. For example, any thermoplastic that when processed according to the present invention will yield a product having the desired properties. Mixtures of thermoplastics may also be used. Generally, the thermoplastics utilized in the composite fabric include at least one selected from the group consisting of polyolefins, polyvinyl chloride (PVC), urethane, nylons, fluorocarbons, polyethylene, polypropylene, thermoset or thermoplastic polyurethane, polystyrene, high impact strength polystyrenes, cellulosic resins, acrylic resins, polyphenylene oxides and polyphenylene sulfide. Preferably, the top sheet thermoplastic utilized in the composite fabric is PVC.

Further, the top sheet thermoplastic layer 108 does not have to be white, it could be colored, such as blue, green, etc. An additional thermoplastic layer 110 underlies the first side 104 of the scrim sheet 102, wherein the adhesive 112 bonds the thermoplastic layer 110 to the scrim sheet 102. The additional thermoplastic layer 110 can be 1-5 mils. thick. The additional thermoplastic layer 110 is typically a blackout flexible PVC layer, but can be any thermoplastic. As stated supra, any thermoplastics or mixtures of thermoplastics that when processed according to the present invention will yield a product having the desired properties. Preferably, the additional thermoplastic layer 110 utilized in the composite fabric is PVC. Furthermore, the blackout flexible PVC layer 110 does not have to be black, but could be an opaque color, including green, grey or silver.

Additionally, an abrasion resistant film layer 114 underlies the additional thermoplastic layer 110. The abrasion resistant film layer 114 can be 0.1-5 mils. thick. Preferably the abrasion resistant film layer is a Mylar® layer 114, but could be any similar material, such as a polyester film or plastic sheet made from resin Polyethylene Terephthalate (PET), Tedlar®, a polyvinyl fluoride (PVF) film, polyvinylidene fluoride (PVDF), a thermoplastic fluoropolymer, high-density polyethylene (HDPE), acrylic, nylon, or polyurethane. Further, a bottom sheet thermoplastic layer 116 underlies the abrasion resistant film layer 114. The bottom sheet thermoplastic layer 116 can be 2-20 mils. thick. The bottom sheet thermoplastic layer 116 is typically a white flexible PVC layer, but can be any thermoplastic. As stated supra, any thermoplastics or mixtures of thermoplastics that when processed according to the present invention will yield a product having the desired properties. Preferably, the bottom sheet thermoplastic layer 116 utilized in the composite fabric is PVC. Furthermore, the white flexible PVC layer 116 does not have to be white, it could be colored, such as blue, green, etc.

Further, an adhesive 118 is applied to both sides of the abrasion resistant film layer 114 to bond the abrasion resistant film layer 114 to the thermoplastic layers 110 and 116. The adhesive 118 can be 0.1-5 mils. thick. Typically, the adhesive 118 is a polyester adhesive or a urethane adhesive for adhering to the abrasion resistant film layer 114. It can also be an adhesive for polyester and not necessarily a polyester adhesive. Generally, the abrasion resistant film layer 114 is positioned on top of the top sheet thermoplastic layer 108, however the addition of the abrasion resistant film layer 114 between the thermoplastic layer 110 and the bottom sheet thermoplastic layer 116 improves the thermal seal qualities of the abrasion resistant film layer 114. Typically, abrasion resistant film exhibits poor thermal seal qualities, however positioning the abrasion resistant film layer 114 between two thermoplastic layers improves the thermal seal qualities of the abrasion resistant film layer 114 and acts to provide increased abrasion resistance to the composite fabric 100. Furthermore, the abrasion resistant film layer 114 does not need the adhesive 118 to bond to the thermoplastic layers 110 and 116, the abrasion resistant film 114 can be self-adhering and bond directly to the thermoplastic layers 110 and 116 without the adhesive 118.

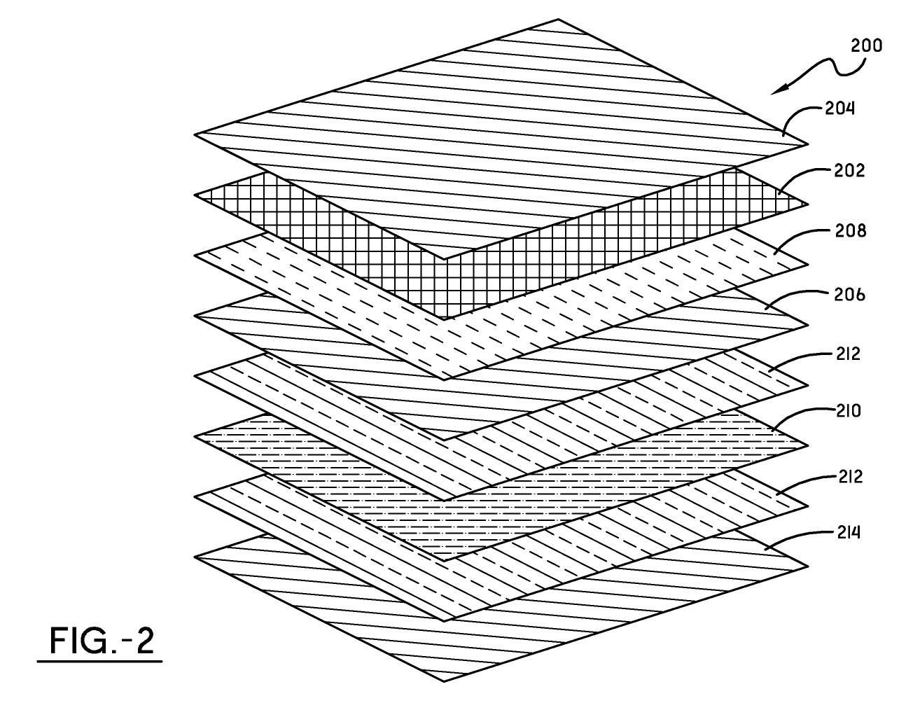

In more detail, FIG. 2 illustrates an exploded view of the composite fabric. The composite fabric 200 comprises a scrim sheet 202 and an underlying adhesive layer 208. The scrim sheet 202 is a web-like fabric layer that is strong and flexible. The scrim sheet 202 can be from 0.5-10 oz. The scrim sheet 202 is combined with an adhesive as a set and then laminated with the adhesive layer 208. The adhesive layer 208 can be from 0.1-5 mils. thick. Typically, the adhesive layer 208 is a plastisol. The fabric layer is black or opaque and is laminated with a black adhesive or opaque adhesive to offer more protection against pinholes.

Further, a top sheet thermoplastic layer 204 overlays a second side (not shown) of the scrim sheet 202. The top sheet thermoplastic layer 204 can be 2-20 mils. thick. The top sheet thermoplastic layer 204 is typically a white, flexible polyvinyl chloride (PVC) layer, but can be any thermoplastic or mixture of thermoplastics as listed supra. Furthermore, the top sheet thermoplastic layer 204 does not have to be white, it could be colored, such as blue, green, etc.

An additional thermoplastic layer 206 underlies a first side (not shown) of the scrim sheet 202, wherein the adhesive 208 bonds the thermoplastic layer 206 to the scrim sheet 202. The additional thermoplastic layer 206 can be 1-5 mils. thick. The additional thermoplastic layer 206 is typically a blackout flexible PVC layer, but can be any thermoplastic or mixture of thermoplastics as listed supra. Furthermore, the blackout flexible PVC layer 206 does not have to be black, but could be an opaque color, including green, grey or silver.

Additionally, an abrasion resistant film layer 210 underlies the additional thermoplastic layer 206. The abrasion resistant film layer 210 can be 0.1-5 mils. thick. Preferably the abrasion resistant film layer is a Mylar® layer 210, but could be any similar material as listed supra. Further, a bottom sheet thermoplastic layer 214 underlies the abrasion resistant film layer 210. The bottom sheet thermoplastic layer 214 can be 2-20 mils. thick. The bottom sheet thermoplastic layer 214 is typically a white flexible PVC layer, but can be any thermoplastic or mixture of thermoplastics as listed supra. Furthermore, the white flexible PVC layer 214 does not have to be white, it could be colored, such as blue, green, etc.

Further, an adhesive 212 is applied to both sides of the abrasion resistant film layer 210 to bond the abrasion resistant film layer 210 to the thermoplastic layers 206 and 214. The adhesive 212 can be 0.1-5 mils. thick. Typically, the adhesive 212 is a polyester adhesive or a urethane adhesive for adhering to the abrasion resistant film layer 210. Preferably, a black or opaque scrim sheet 202, a black or opaque adhesive layer 208, and a black or opaque thermoplastic layer 206 are used to form a blackout layer. The abrasion resistant film layer 210 is then utilized to further protect the blackout layer. Furthermore, the abrasion resistant film layer 210 does not need the adhesive 212 to bond to the thermoplastic layers 206 and 214, the abrasion resistant film 210 can be self-adhering and bond directly to the thermoplastic layers 206 and 214 without the adhesive 212.

Furthermore, it is contemplated that the above composite layers can be interchangeable without affecting the overall concept of the invention. Illustrative aspects are described herein in connection with the following description and the annexed drawings to further illustrate such interchangeability. These aspects are indicative, however, of but a few of the various ways in which the layers disclosed herein can be employed and interchanged, and the contemplated invention is intended to include all such aspects and their equivalents.

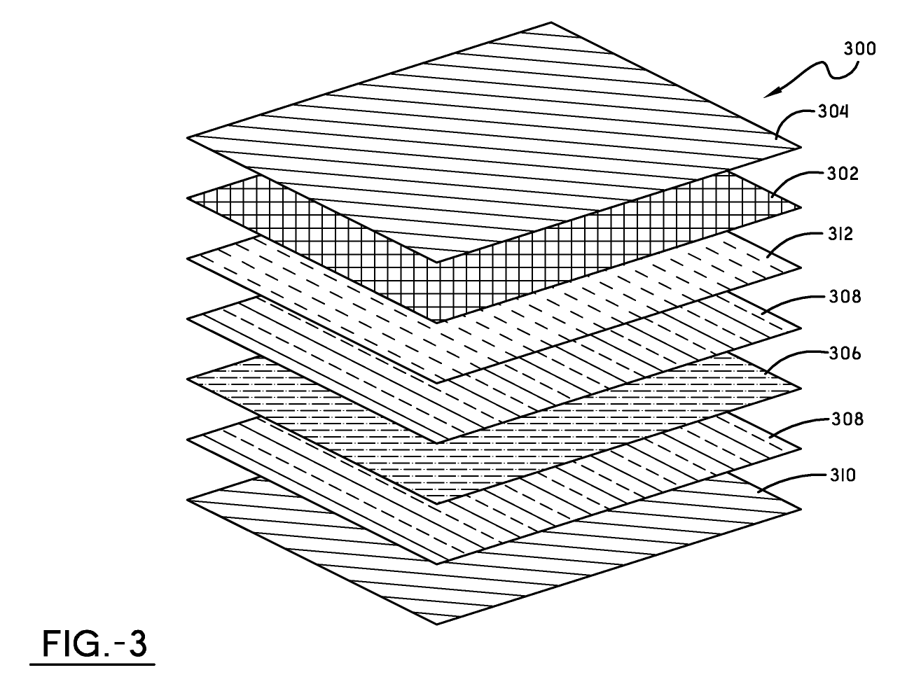

FIG. 3 illustrates an exploded view of the composite fabric wherein a black-out layer (PVC) is removed. The composite fabric 300 comprises a scrim sheet 302 and an underlying adhesive layer 312. The scrim sheet 302 is a web-like fabric layer that is strong and flexible. The scrim sheet 302 can be from 0.5-10 oz. The scrim sheet 302 is combined with an adhesive as a set and then laminated with the adhesive layer 312. The adhesive layer 312 can be from 0.1-5 mils. thick. Typically, the adhesive layer 312 is a plastisol. The fabric layer is black or opaque and is laminated with a black adhesive or opaque adhesive to offer more protection against pinholes.

Further, a top sheet thermoplastic layer 304 overlays a second side (not shown) of the scrim sheet 302. The top sheet thermoplastic layer 304 can be 2-20 mils. thick. The top sheet thermoplastic layer 304 is typically a white, flexible polyvinyl chloride (PVC) layer, but can be any thermoplastic or mixture of thermoplastics as listed supra. Furthermore, the top sheet thermoplastic layer 304 does not have to be white, it could be colored, such as blue, green, etc.

Additionally, an abrasion resistant film layer 306 underlies the adhesive layer 312. The abrasion resistant film layer 306 can be 0.1-5 mils. thick. Preferably the abrasion resistant film layer is a Mylar® layer 306, but could be any similar material as listed supra. Further, a bottom sheet thermoplastic layer 310 underlies the abrasion resistant film layer 306. The bottom sheet thermoplastic layer 310 can be 2-20 mils. thick. The bottom sheet thermoplastic layer 310 is typically a white flexible PVC layer, but can be any thermoplastic or mixture of thermoplastics as listed supra. Furthermore, the white flexible PVC layer 310 does not have to be white, it could be colored, such as blue, green, etc.

Further, an adhesive 308 is applied to both sides of the abrasion resistant film layer 306 to bond the abrasion resistant film layer 306 to the thermoplastic layer 310. The adhesive 308 can be 0.1-5 mils. thick. Typically, the adhesive 308 is a polyester adhesive or a urethane adhesive for adhering to the abrasion resistant film layer 306. It can also be an adhesive for polyester and not necessarily a polyester adhesive. Furthermore, the abrasion resistant film layer 306 does not need the adhesive 308 to bond to the thermoplastic layer 310, the abrasion resistant film 306 can be self-adhering and bond directly to the thermoplastic layer 310 without the adhesive 308.

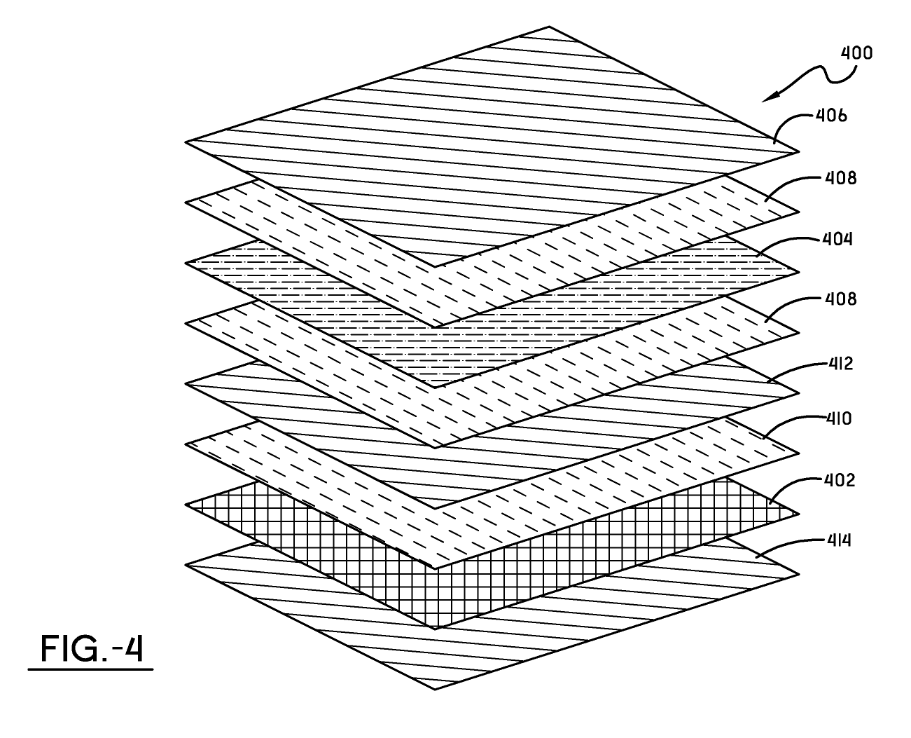

Furthermore, FIG. 4 illustrates an exploded view of the composite fabric wherein the abrasion resistant film layer is positioned on the opposite side of the scrim sheet. The composite fabric 400 comprises a scrim sheet 402 and an overlaying adhesive layer 410. The scrim sheet 402 is a web-like fabric layer that is strong and flexible. The scrim sheet 402 can be from 0.5-10 oz. The scrim sheet 402 is combined with an adhesive as a set and then laminated with the overlaying adhesive layer 410. The adhesive layer 410 can be from 0.1-5 mils. thick. Typically, the adhesive layer 410 is a plastisol. The fabric layer is black or opaque and is laminated with a black adhesive or opaque adhesive to offer more protection against pinholes.

Further, a bottom sheet thermoplastic layer 414 underlies a first side (not shown) of the scrim sheet 402. The bottom sheet thermoplastic layer 414 can be 2-20 mils. thick. The bottom sheet thermoplastic layer 414 is typically a white, flexible polyvinyl chloride (PVC) layer, but can be any thermoplastic or mixture of thermoplastics as listed supra. Furthermore, the bottom sheet thermoplastic layer 414 does not have to be white, it could be colored, such as blue, green, etc.

An additional thermoplastic layer 412 overlays a second side (not shown) of the scrim sheet 402, wherein the adhesive 410 bonds the thermoplastic layer 412 to the scrim sheet 402. The additional thermoplastic layer 412 can be 1-5 mils. thick. The additional thermoplastic layer 412 is typically a blackout flexible PVC layer, but can be any thermoplastic or mixture of thermoplastics as listed supra. Furthermore, the blackout flexible PVC layer 412 does not have to be black, but could be an opaque color, including green, grey or silver.

Additionally, an abrasion resistant film layer 404 overlays the additional thermoplastic layer 412. The abrasion resistant film layer 404 can be 0.1-5 mils. thick. Preferably the abrasion resistant film layer is a Mylar® layer 404, but could be any similar material as listed supra. Further, a top sheet thermoplastic layer 406 overlays the abrasion resistant film layer 404. The top sheet thermoplastic layer 406 can be 2-20 mils. thick. The top sheet thermoplastic layer 406 is typically a white flexible PVC layer, but can be any thermoplastic or mixture of thermoplastics as listed supra. Furthermore, the white flexible PVC layer 406 does not have to be white, it could be colored, such as blue, green, etc.

Further, an adhesive 408 is applied to both sides of the abrasion resistant film layer 404 to bond the abrasion resistant film layer 404 to the thermoplastic layers 406 and 412. The adhesive 408 can be 0.1-5 mils. thick. Typically, the adhesive 408 is a polyester adhesive or a urethane adhesive for adhering to the abrasion resistant film layer 404. Preferably, a black or opaque scrim sheet 402, a black or opaque adhesive layer 410, and a black or opaque thermoplastic layer 412 are used to form a blackout layer. The abrasion resistant film layer 404 is then utilized to further protect the blackout layer. Furthermore, the abrasion resistant film layer 404 does not need the adhesive 408 to bond to the thermoplastic layers 406 and 412, the abrasion resistant film 404 can be self-adhering and bond directly to the thermoplastic layers 406 and 412 without the adhesive 408.

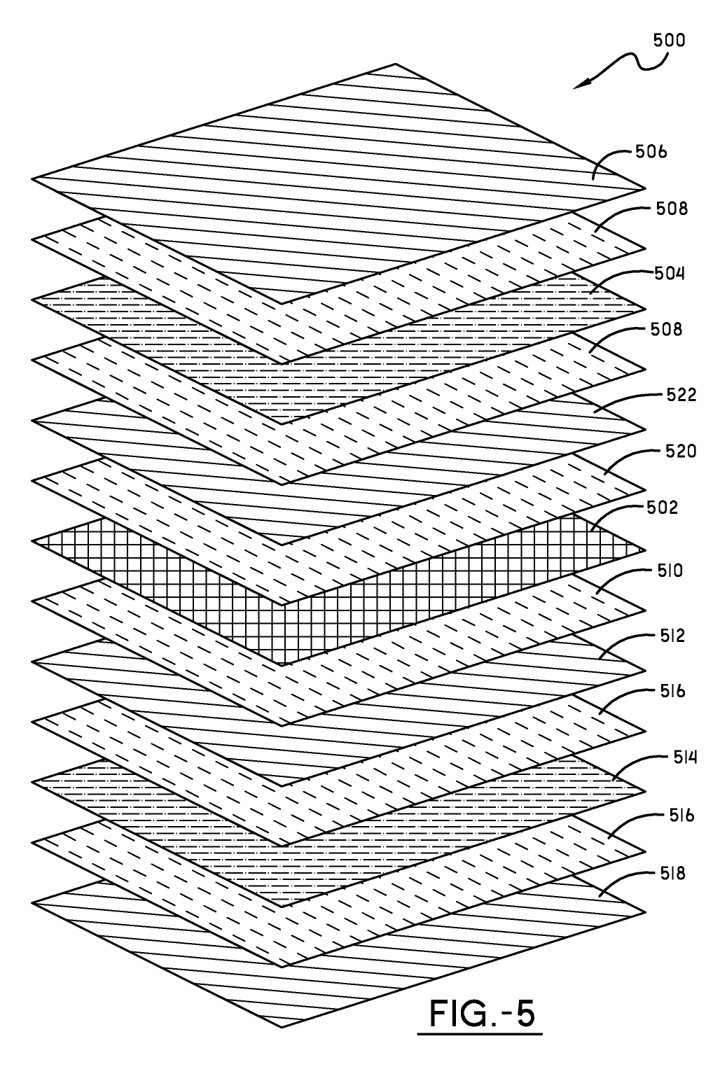

FIG. 5 illustrates an exploded view of the composite fabric wherein the abrasion resistant film layer is positioned on both sides of the scrim sheet. The composite fabric 500 comprises a scrim sheet 502 and an underlying adhesive layer 510. The scrim sheet 502 is a web-like fabric layer that is strong and flexible. The scrim sheet 502 can be from 0.5-10 oz. The scrim sheet 502 is combined with an adhesive as a set and then laminated with the adhesive layer 510. The adhesive layer 510 can be from 0.1-5 mils. thick. Typically, the overlaying adhesive layer 510 is a plastisol. The fabric layer is black or opaque and is laminated with a black adhesive or opaque adhesive to offer more protection against pinholes.

An additional thermoplastic layer 512 underlies a first side (not shown) of the scrim sheet 502, wherein the adhesive 510 bonds the thermoplastic layer 512 to the scrim sheet 502. The additional thermoplastic layer 512 can be 1-5 mils. thick. The additional thermoplastic layer 512 is typically a blackout flexible PVC layer, but can be any thermoplastic or mixture of thermoplastics as listed supra. Furthermore, the blackout flexible PVC layer 512 does not have to be black, but could be an opaque color, including green, grey or silver.

Additionally, an abrasion resistant film layer 514 underlies the additional thermoplastic layer 512. The abrasion resistant film layer 514 can be 0.1-5 mils. thick. Preferably the abrasion resistant film layer is a Mylar® layer 514, but could be any similar material as listed supra. Further, a bottom sheet thermoplastic layer 518 underlies the abrasion resistant film layer 514. The bottom sheet thermoplastic layer 518 can be 2-20 mils. thick. The bottom sheet thermoplastic layer 518 is typically a white flexible PVC layer, but can be any thermoplastic or mixture of thermoplastics as listed supra. Furthermore, the white flexible PVC layer 518 does not have to be white, it could be colored, such as blue, green, etc.

Further, an adhesive 516 is applied to both sides of the abrasion resistant film layer 514 to bond the abrasion resistant film layer 514 to the thermoplastic layers 512 and 518. The adhesive 516 can be 0.1-5 mils. thick. Typically, the adhesive 516 is a polyester adhesive or a urethane adhesive for adhering to the abrasion resistant film layer 514. It can also be an adhesive for polyester and not necessarily a polyester adhesive. Furthermore, the abrasion resistant film layer 514 does not need the adhesive 516 to bond to the thermoplastic layers 512 and 518, the abrasion resistant film 514 can be self-adhering and bond directly to the thermoplastic layers 512 and 518 without the adhesive 516.

An additional thermoplastic layer 522 overlays a second side (not shown) of the scrim sheet 502, wherein an adhesive 520 bonds the thermoplastic layer 522 to the scrim sheet 502. The additional thermoplastic layer 522 can be 1-5 mils. thick. The additional thermoplastic layer 522 is typically a blackout flexible PVC layer, but can be any thermoplastic or mixture of thermoplastics as listed supra. Furthermore, the blackout flexible PVC layer 522 does not have to be black, but could be an opaque color, including green, grey or silver.

Additionally, an abrasion resistant film layer 504 overlays the additional thermoplastic layer 522. The abrasion resistant film layer 504 can be 0.1-5 mils. thick. Preferably the abrasion resistant film layer is a Mylar® layer 504, but could be any similar material as listed supra. Further, a top sheet thermoplastic layer 506 overlays the abrasion resistant film layer 504. The top sheet thermoplastic layer 506 can be 2-20 mils. thick. The top sheet thermoplastic layer 506 is typically a white flexible PVC layer, but can be any thermoplastic or mixture of thermoplastics as listed supra. Furthermore, the white flexible PVC layer 506 does not have to be white, it could be colored, such as blue, green, etc.

Further, an adhesive 508 is applied to both sides of the abrasion resistant film layer 504 to bond the abrasion resistant film layer 504 to the overlaying thermoplastic layers 506 and 522. The adhesive 508 can be 0.1-5 mils. thick. Typically, the adhesive 508 is a polyester adhesive or a urethane adhesive for adhering to the abrasion resistant film layer 504. It can also be an adhesive for polyester and not necessarily a polyester adhesive. As stated supra, the abrasion resistant film layer 504 does not need the adhesive 508 to bond to the thermoplastic layers 506 and 522, the abrasion resistant film 504 can be self-adhering and bond directly to the thermoplastic layers 506 and 522 without the adhesive 508.

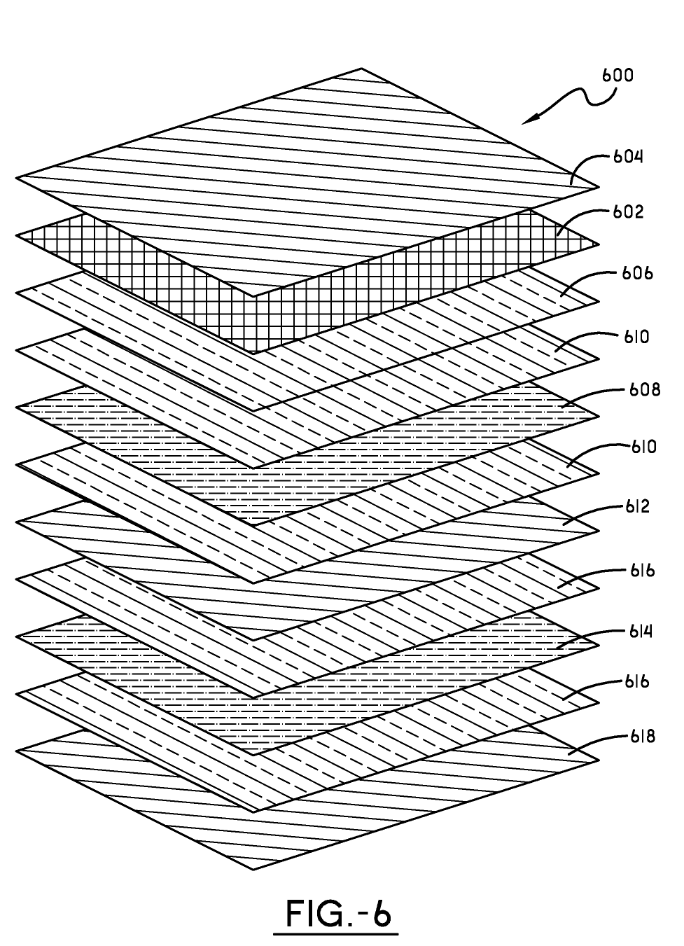

FIG. 6 illustrates an exploded view of the composite fabric wherein there are two abrasion resistant film layers positioned on top of one another. The composite fabric 600 comprises a scrim sheet 602 and an underlying adhesive layer 606. The scrim sheet 602 is a web-like fabric layer that is strong and flexible. The scrim sheet 602 can be from 0.5-10 oz. The scrim sheet 602 is combined with an adhesive as a set and then laminated with the adhesive layer 606. The adhesive layer 606 can be from 0.1-5 mils. thick. Typically, the adhesive layer 606 is a plastisol. The fabric layer is black or opaque and is laminated with a black adhesive or opaque adhesive to offer more protection against pinholes.

Further, a top sheet thermoplastic layer 604 overlays a second side (not shown) of the scrim sheet 602. The top sheet thermoplastic layer 604 can be 2-20 mils. thick. The top sheet thermoplastic layer 604 is typically a white, flexible polyvinyl chloride (PVC) layer, but can be any thermoplastic or mixture of thermoplastics as listed supra. Furthermore, the top sheet thermoplastic layer 604 does not have to be white, it could be colored, such as blue, green, etc.

A first abrasion resistant film layer 608 underlies a first side (not shown) of the scrim sheet 602. The first abrasion resistant film layer 608 can be 0.1-5 mils. thick. Preferably the abrasion resistant film layer is a Mylar® layer 608, but could be any similar material as listed supra. Further, an adhesive 610 is applied to both sides of the first abrasion resistant film layer 608 to bond the abrasion resistant film layer 608 to the scrim sheet 602. The adhesive 610 can be 0.1-5 mils. thick. Typically, the adhesive 610 is a polyester adhesive or a urethane adhesive for adhering to the abrasion resistant film layer 608. Furthermore, the first abrasion resistant film layer 608 does not need the adhesive 610 to bond to the scrim sheet 602, the abrasion resistant film 608 can be self-adhering and bond directly to the scrim sheet 602 without the adhesive 610.

An additional thermoplastic layer 612 underlies the first abrasion resistant film layer 608. The additional thermoplastic layer 612 can be 1-5 mils. thick. The additional thermoplastic layer 612 is typically a blackout flexible PVC layer, but can be any thermoplastic or mixture of thermoplastics as listed supra. Furthermore, the blackout flexible PVC layer 612 does not have to be black, but could be an opaque color, including green, grey or silver.

Additionally, a second abrasion resistant film layer 614 underlies the additional thermoplastic layer 612. The second abrasion resistant film layer 614 can be 0.1-5 mils. thick. Preferably the abrasion resistant film layer is a Mylar® layer 614, but could be any similar material as listed supra. Further, a bottom sheet thermoplastic layer 618 underlies the second abrasion resistant film layer 614. The bottom sheet thermoplastic layer 618 can be 2-20 mils. thick. The bottom sheet thermoplastic layer 618 is typically a white flexible PVC layer, but can be any thermoplastic or mixture of thermoplastics as listed supra. Furthermore, the white flexible PVC layer 618 does not have to be white, it could be colored, such as blue, green, etc.

Further, an adhesive 616 is applied to both sides of the second abrasion resistant film layer 614 to bond the second abrasion resistant film layer 614 to the thermoplastic layers 612 and 618. The adhesive 616 can be 0.1-5 mils. thick. Typically, the adhesive 616 is a polyester adhesive or a urethane adhesive for adhering to the second abrasion resistant film layer 614. Furthermore, the second abrasion resistant film layer 614 does not need the adhesive 616 to bond to the thermoplastic layers 612 and 618, the abrasion resistant film 614 can be self-adhering and bond directly to the thermoplastic layers 612 and 618 without the adhesive 616.

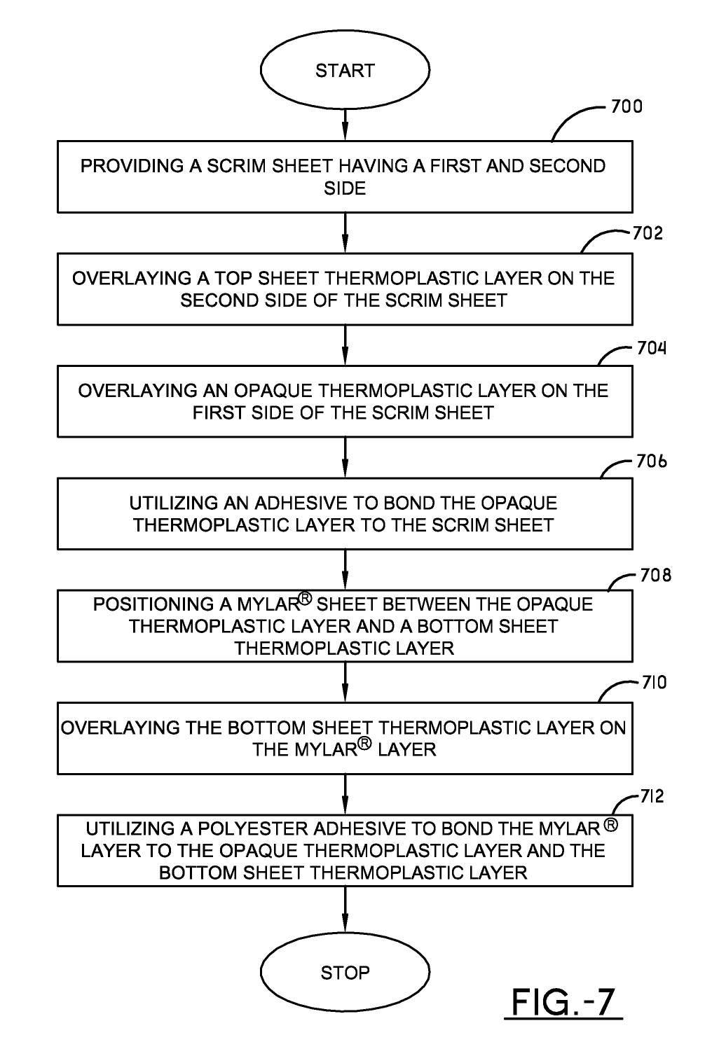

FIG. 7 illustrates methodologies of fabricating the composite fabric, according to various aspects of the innovation. While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 7, a method of fabricating the composite fabric is illustrated. At 700, a scrim sheet having a first and second side is provided. The scrim sheet is a web-like fabric layer that is strong and flexible. The scrim sheet can be from 0.5-10 oz. The scrim sheet is combined with an adhesive as a set and then laminated with an adhesive layer. The fabric sheet is black or opaque and is laminated with a black adhesive or opaque adhesive to offer more protection against pinholes.

At 702, a top sheet thermoplastic layer is overlaid on the second side of the scrim sheet. The top sheet thermoplastic layer can be 2-20 mils. thick. The top sheet thermoplastic layer is typically a white, flexible polyvinyl chloride (PVC) layer, but can be any thermoplastic or mixture of thermoplastics as listed supra. Furthermore, the top sheet thermoplastic layer does not have to be white, it could be colored, such as blue, green, etc.

At 704, an opaque thermoplastic layer is overlaid on the first side of the scrim sheet. The opaque thermoplastic layer can be 1-5 mils. thick. The opaque thermoplastic layer is typically a blackout flexible PVC layer, but can be any thermoplastic or mixture of thermoplastics as listed supra. Furthermore, the blackout flexible PVC layer does not have to be black, but could be an opaque color, including green, grey or silver.

At 706, an adhesive is utilized to bond the opaque thermoplastic layer to the scrim sheet. The adhesive can be from 0.1-5 mils. thick. Typically, the adhesive is a plastisol. At 708, a Mylar® layer is positioned in between the opaque thermoplastic layer and a bottom sheet thermoplastic layer. The Mylar® layer can be 0.1-5 mils. thick. Preferably the layer is a Mylar® layer, but could be any similar material as listed supra.

At 710, a bottom sheet thermoplastic layer is overlayed on the Mylar® layer. The bottom sheet thermoplastic layer can be 2-20 mils. thick. The bottom sheet thermoplastic layer is typically a white flexible PVC layer, but can be any thermoplastic or mixture of thermoplastics as listed supra. Furthermore, the white, flexible PVC layer does not have to be white, it could be colored, such as blue, green, etc.

And, at 712 a polyester adhesive is utilized to bond the Mylar® layer to the opaque thermoplastic layer and the bottom sheet thermoplastic layer. Specifically, the polyester adhesive is applied to both sides of the Mylar® layer to bond the Mylar® layer to the overlaying thermoplastic layers. The polyester adhesive can be 0.1-5 mils. thick. Typically, the adhesive is a polyester adhesive or a urethane adhesive for adhering to the Mylar® layer. It can also be an adhesive for polyester and not necessarily a polyester adhesive.

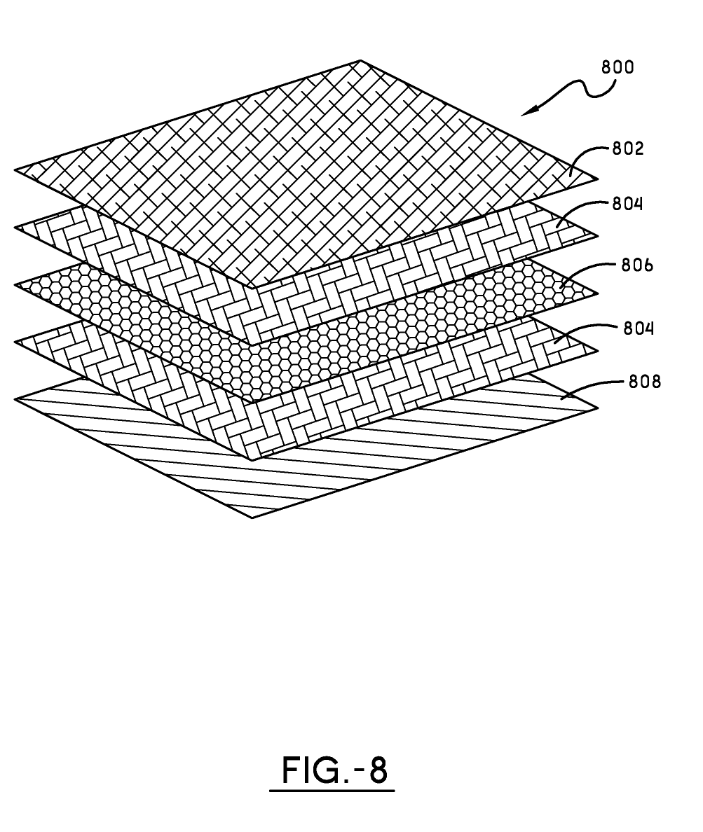

FIG. 8 illustrates an embodiment of the composite fabric. The composite fabric 800 comprises a blackout thermoplastic layer 806, which is typically from 2-4 oz. The blackout thermoplastic layer 806 is black or opaque, and is typically a blackout flexible PVC layer, but can be any thermoplastic or mixture of thermoplastics as listed supra. Furthermore, the blackout thermoplastic layer 806 can, if needed, be laminated with a black adhesive or opaque adhesive to offer more protection against pinholes, as is known in the art.

Additionally, ripstop cloth layers 804 are positioned on the top and bottom of the blackout thermoplastic layer 806. The ripstop cloth layers 804 can be 0.25-4 oz. The ripstop cloth layers 804 are a closely woven fabric that acts to protect the blackout thermoplastic layer 806 from abrasion and puncture. Preferably, the ripstop cloth layers 804 have a thermoplastic coating that acts as an adhesive to bond the opaque thermoplastic layer 806 to the ripstop cloth layers 804, the thermoplastic coating may also add chemical permeation protection properties to the composite fabric 800.

Further, a top sheet thermoplastic layer 802 overlays the first ripstop cloth layer 804. The top sheet thermoplastic layer 802 can be 2-20 mils. thick. The top sheet thermoplastic layer 802 is typically a white, flexible PVC layer, but can be any thermoplastic or mixture of thermoplastics as listed supra. Furthermore, the top sheet thermoplastic layer 802 does not have to be white, it could be colored, such as blue, green, etc.

Finally, a bottom sheet thermoplastic layer 808 underlies the second ripstop cloth layer 804. The bottom sheet thermoplastic layer 808 can be 2-20 mils. thick. The bottom sheet thermoplastic layer 808 is typically a white flexible PVC layer, but can be any thermoplastic or mixture of thermoplastics as listed supra. Furthermore, the white flexible PVC layer 808 does not have to be white, it could be colored, such as blue, green, etc.

Thus, the ripstop cloth 804 is positioned on the inside of the composite fabric 800 while an easily heat sealable colored layer (802 and 808) is positioned on the outside top and bottom of the composite fabric 800. This allows fabrication of the composite fabric 800 using conventional thermoplastic methods such as RF welding, hot wedge welding, hot air welding and hot wire welding without buffing off a coating that does not heat seal as easily as a TPE, TPO or flexible PVC, and allows protection of the softer flexible opaque layer 806 with a tough cloth layer 804.

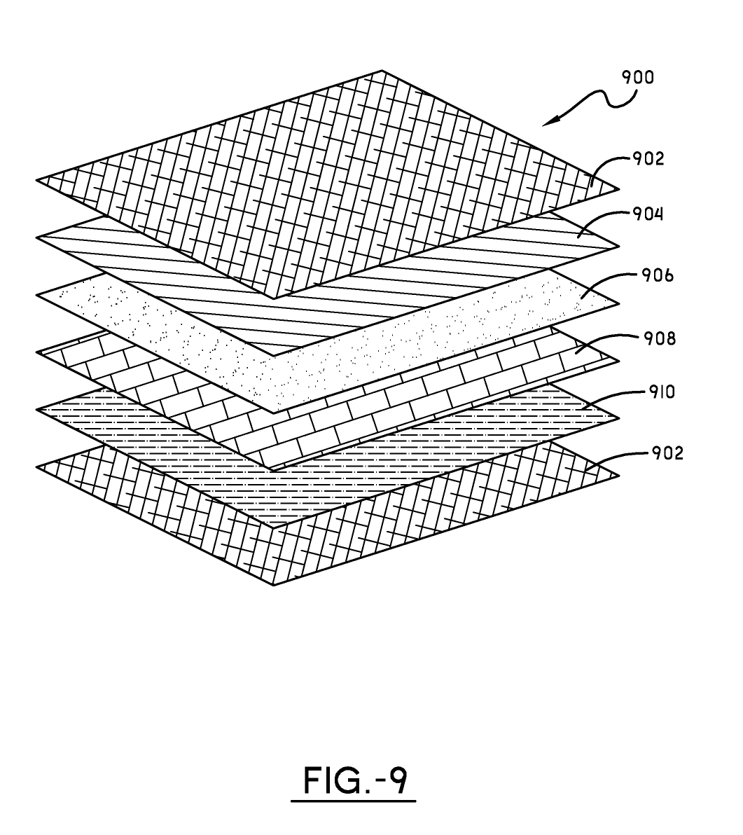

FIG. 9 illustrates another embodiment of the composite fabric. The composite fabric 900 comprises an opaque layer 906, which is typically from 2-20 mils. thick. The opaque layer 906 is black or opaque, and is typically comprised of an opaque yarn impregnated with an opaque adhesive.

Additionally, an abrasion resistant film layer 904 overlays the top of the opaque layer 906. The abrasion resistant film layer 904 can be 0.1-5 mils. thick. The abrasion resistant film layer 904 is a hard film such as Mylar®, HDPE, Tedlar®, acrylic or nylon. The abrasion resistant film layer 904 acts to protect the opaque layer 906 from abrasion and puncture which can occur during the course of handling, erecting, stretching and cleaning of the composite fabric 900. The abrasion resistant film layer 904 may also add chemical permeation protection to the composite fabric 900. Furthermore, the abrasion resistant film layer 904 may have an adhesive applied to it to bond the abrasion resistant layer 904 to the opaque film layer 906, but the abrasion resistant layer 904 does not need the adhesive and can be self-adhering.

Further, a top sheet thermoplastic layer 902 overlays the abrasion resistant film layer 904. The top sheet thermoplastic layer 902 can be 2-20 mils. thick. The top sheet thermoplastic layer 902 is typically a flexible PVC layer, but can be any thermoplastic or mixture of thermoplastics as listed supra. Furthermore, the top sheet thermoplastic layer 902 can be colored, such as blue, green, etc.

Additionally, a scrim or base cloth layer 908 underlies the opaque layer 906. The scrim layer 908 is a web-like fabric layer that is strong and flexible. The scrim layer 908 can be from 0.5-10 oz. The scrim layer 908 is combined with an adhesive as a set and then laminated with an underlying adhesive layer 910. The adhesive layer 910 can be from 0.1-5 oz. The scrim layer 908 is black or opaque and is laminated with an opaque or colored adhesive layer 910 to offer more protection against pinholes or other blemishes.

Finally, a bottom sheet thermoplastic layer 902 underlies the adhesive layer 910. The bottom sheet thermoplastic layer 902 can be 2-20 mils. thick. The bottom sheet thermoplastic layer 902 is typically a flexible PVC layer, but can be any thermoplastic or mixture of thermoplastics as listed supra. Furthermore, the flexible PVC layer 902 can be colored, such as blue, green, etc.

Thus, the abrasion resistant film layer 904 is positioned on the inside of the composite fabric 900 while an easily heat sealable colored layer 902 is positioned on the outside top and bottom of the composite fabric 900. This allows fabrication of the composite fabric 900 using conventional thermoplastic methods such as RF welding, hot wedge welding, hot air welding and hot wire welding without buffing off a coating that does not heat seal as easily as a TPE, TPO or flexible PVC, and allows protection of the softer flexible opaque layer 906 with a (hard film) abrasion resistant layer 904.

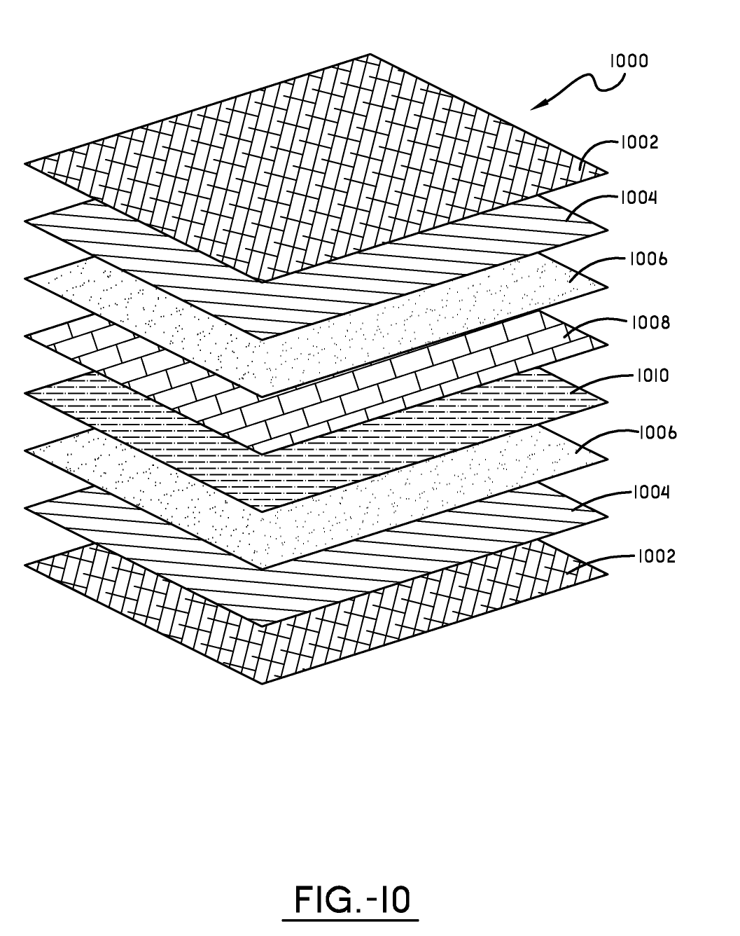

FIG. 10 illustrates another embodiment of the composite fabric. The composite fabric 1000 comprises an opaque film layer 1006, which is typically from 2-20 mils. thick. The opaque film layer 1006 is black or opaque, and is typically a flexible PVC layer, but can be any thermoplastic or mixture of thermoplastics as listed supra. Furthermore, the opaque film layer 1006 can, if needed, be laminated with a black adhesive or opaque adhesive to offer more protection against pinholes, as is known in the art.

Additionally, an abrasion resistant film layer 1004 overlays the top of the opaque film layer 1006. The abrasion resistant film layer 1004 can be 0.1-5 mils. thick. The abrasion resistant film layer 1004 is a hard film such as Mylar®, HDPE, Tedlar®, acrylic or nylon. The abrasion resistant film layer 1004 acts to protect the opaque film layer 1006 from abrasion and puncture which can occur during the course of handling, erecting, stretching and cleaning of the composite fabric 1000. The abrasion resistant film layer 1004 may also add chemical permeation protection to the composite fabric 1000. Furthermore, the abrasion resistant film layer 1004 may have an adhesive applied to it to bond the abrasion resistant layer 1004 to the opaque film layer 1006, but the abrasion resistant layer 1004 does not need the adhesive and can be self-adhering.

Further, a top sheet thermoplastic layer 1002 overlays the abrasion resistant film layer 1004. The top sheet thermoplastic layer 1002 can be 2-20 mils. thick. The top sheet thermoplastic layer 1002 is typically a flexible PVC layer, but can be any thermoplastic or mixture of thermoplastics as listed supra. Furthermore, the top sheet thermoplastic layer 1002 can be colored, such as blue, green, etc.

Additionally, a scrim fabric layer 1008 underlies the opaque film layer 1006. The scrim fabric layer 1008 is a web-like fabric layer that is strong and flexible. The scrim fabric layer 1008 can be from 0.5-10 oz. The scrim fabric layer 1008 is combined with an adhesive as a set and then laminated with an underlying adhesive layer 1010. The underlying adhesive layer 1010 can be from 0.1-5 mils. thick.

Furthermore, an opaque film layer 1006, which is typically from 2-20 mils. thick, underlies the adhesive layer 1010. The opaque film layer 1006 is black or opaque, and is typically a flexible PVC layer, but can be any thermoplastic or mixture of thermoplastics as listed supra. Furthermore, the opaque film layer 1006 can, if needed, be laminated with a black adhesive or opaque adhesive to offer more protection against pinholes, as is known in the art.

Additionally, an abrasion resistant film layer 1004 underlies the opaque film layer 1006. The abrasion resistant film layer 1004 can be 0.1-5 mils. thick. The abrasion resistant film layer 1004 is a hard film such as Mylar®, HDPE, Tedlar®, acrylic or nylon. The abrasion resistant film layer 1004 acts to protect the opaque film layer 1006 from abrasion and puncture which can occur during the course of handling, erecting, stretching and cleaning of the composite fabric 1000. The abrasion resistant film layer 1004 may also add chemical permeation protection to the composite fabric 1000. As stated supra, the abrasion resistant film layer 1004 may have an adhesive applied to it to bond the abrasion resistant layer 1004 to the opaque film layer 1006, but the abrasion resistant layer 1004 does not need the adhesive and can be self-adhering.

Finally, a bottom sheet thermoplastic layer 1002 underlies the abrasion resistant layer 1004. The bottom sheet thermoplastic layer 1002 can be 2-20 mils. thick. The bottom sheet thermoplastic layer 1002 is typically a flexible PVC layer, but can be any thermoplastic or mixture of thermoplastics as listed supra. Furthermore, the flexible PVC layer 1002 can be colored, such as blue, green, etc.

The top and bottom thermoplastic sheets 1002 are utilized as is known in the art, thus the composite fabric 1000 can have a top coating and/or a bottom coating or neither a top or bottom coating.

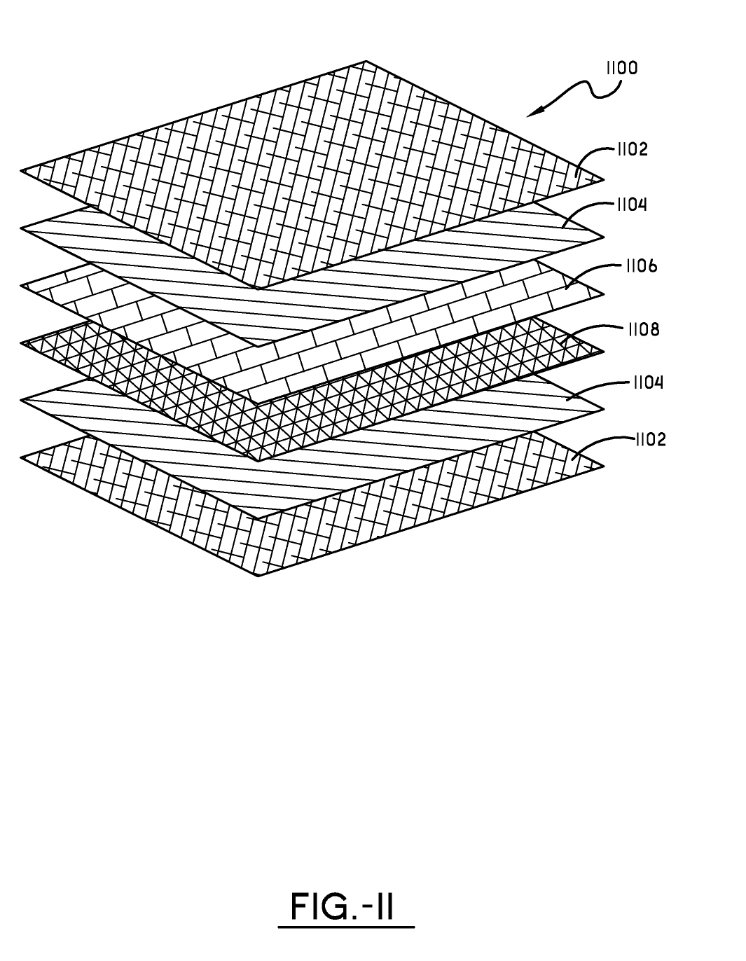

FIG. 11 illustrates another embodiment of the composite fabric. The composite fabric 1100 comprises a scrim or base cloth layer 1106. The scrim layer 1106 is a web-like fabric layer that is strong and flexible. The scrim layer 1106 can be from 0.5-10 oz. and is typically black or opaque colored. The scrim layer 1106 is combined with a saturating adhesive layer 1108 as a set. The saturating adhesive layer 1108 can be from 2-10 mils. thick.

Additionally, an abrasion resistant film layer 1104 overlays the top side of the scrim layer 1106. The abrasion resistant film layer 1104 can be 0.1-5 mils. thick. The abrasion resistant film layer 1104 is a hard film such as Mylar®, HDPE, Tedlar®, acrylic or nylon. The abrasion resistant film layer 1104 acts to protect the scrim layer 1106 from abrasion and puncture which can occur during the course of handling, erecting, stretching and cleaning of the composite fabric 1100. The abrasion resistant film layer 1104 may also add chemical permeation protection to the composite fabric 1100. Further, the abrasion resistant film layer 1104 may have an adhesive applied to it to bond the abrasion resistant layer 1104 to the scrim layer 1106, but the abrasion resistant layer 1104 does not need the adhesive and can be self-adhering.

Further, a top sheet thermoplastic layer 1102 overlays the abrasion resistant film layer 1104. The top sheet thermoplastic layer 1102 can be 2-20 mils. thick, and is typically a flexible PVC layer, but can be any thermoplastic or mixture of thermoplastics as listed supra. Furthermore, the top sheet thermoplastic layer 1102 can be colored, such as blue, green, etc. The composite fabric 1100 can also be constructed without the top sheet thermoplastic layer 1102.

Additionally, a second abrasion resistant film layer 1104 underlies the adhesive saturating scrim layer 1108. The abrasion resistant film layer 1104 can be 0.1-5 mils. thick and is a hard film such as Mylar®, HDPE, Tedlar®, acrylic or nylon. As stated supra, the abrasion resistant film layer 1104 may have an adhesive applied to it to bond the abrasion resistant layer 1104 to the scrim layer 1106, but the abrasion resistant layer 1104 does not need the adhesive and can be self-adhering.

Finally, a second or bottom sheet thermoplastic layer 1102 underlies the second abrasion resistant film layer 1104. The bottom sheet thermoplastic layer 1102 can be 2-20 mils. thick, and is typically a flexible PVC layer, but can be any thermoplastic or mixture of thermoplastics as listed supra. Furthermore, the flexible PVC layer 1102 can be colored, such as blue, green, etc. The composite fabric 1100 can also be constructed without the bottom sheet thermoplastic layer 1102.

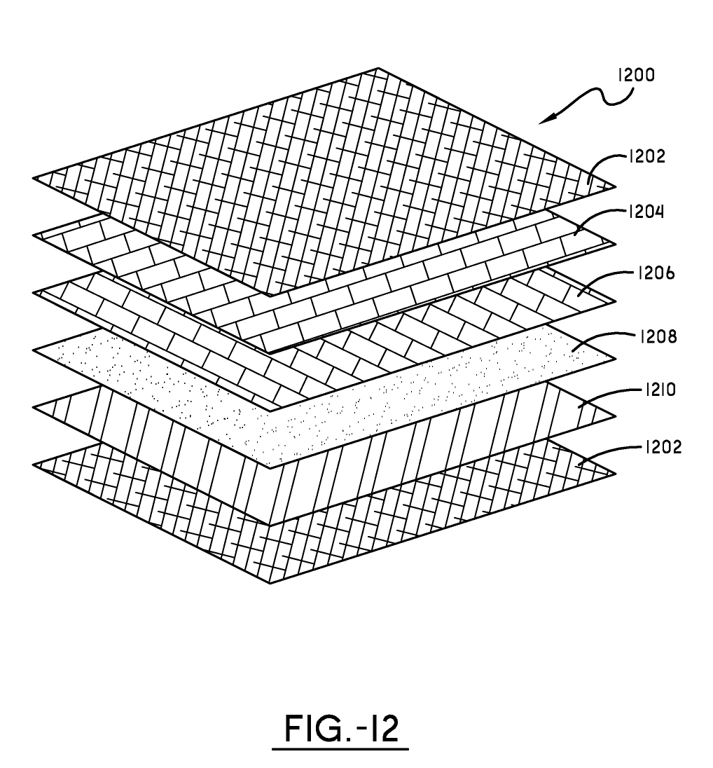

FIG. 12 illustrates another embodiment of the composite fabric. The composite fabric 1200 comprises a scrim or base cloth layer 1204. The scrim layer 1204 is a web-like fabric layer that is strong and flexible. The scrim layer 1204 can be from 0.5-10 oz. and is typically black or opaque colored. The scrim layer 1204 is combined with a saturating adhesive layer 1206 as a set. The saturating adhesive layer 1206 can be from 2-10 mils. thick.

Further, a top sheet thermoplastic layer 1202 overlays the top side of the scrim layer 1204. The top sheet thermoplastic layer 1202 can be from 2-20 mils. thick, and is typically a flexible PVC layer, but can be any thermoplastic or mixture of thermoplastics as listed supra. Furthermore, the top sheet thermoplastic layer 1202 can be colored, such as blue, green, etc. The composite fabric 1200 can also be constructed without the top sheet thermoplastic layer 1202.

Additionally, an opaque film layer 1208, which can be from 2-20 mils. thick, underlies the adhesive saturating scrim layer 1206. The opaque film layer 1208 is black or opaque, and is typically a flexible PVC layer, but can be any thermoplastic or mixture of thermoplastics as listed supra. Furthermore, the opaque film layer 1208 can, if needed, be laminated with a black adhesive or opaque adhesive to offer more protection against pinholes, as is known in the art.

Further, an abrasion resistance film layer 1210 underlies the opaque film layer 1208. The abrasion resistant film layer 1210 can be 0.1-5 mils. thick and is a hard film such as Mylar®, HDPE, Tedlar®, acrylic or nylon. Furthermore, the abrasion resistant film layer 1210 may have an adhesive applied to it to bond the abrasion resistant layer 1210 to the opaque film layer 1208, but the abrasion resistant layer 1210 does not need the adhesive and can be self-adhering.

Finally, a second or bottom sheet thermoplastic layer 1202 underlies the abrasion resistant film layer 1210. The bottom sheet thermoplastic layer 1202 can be from 2-20 mils. thick, and is typically a flexible PVC layer, but can be any thermoplastic or mixture of thermoplastics as listed supra. Furthermore, the flexible PVC layer 1202 can be colored, such as blue, green, etc. The composite fabric 1200 can also be constructed without the bottom sheet thermoplastic layer 1202.

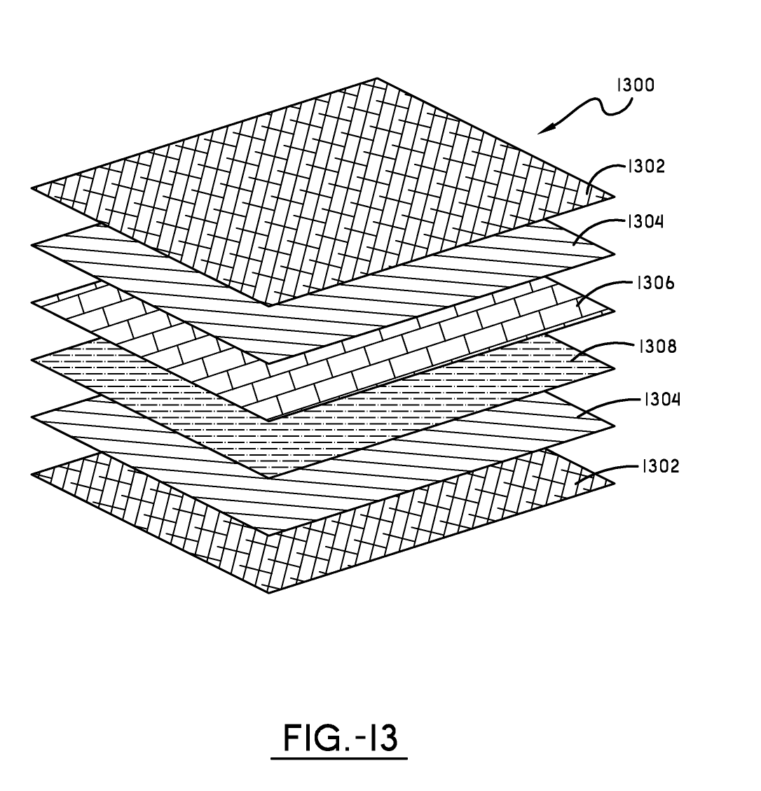

FIG. 13 illustrates another embodiment of the composite fabric. The composite fabric 1300 comprises a scrim or base cloth layer 1306. The scrim layer 1306 is a web-like fabric layer that is strong and flexible. The scrim layer 1306 can be from 0.5-10 oz. and can be combined with an adhesive as a set or used alone. The scrim layer 1306 is then laminated with an underlying adhesive layer 1308. The adhesive layer 1308 can be from 0.1-5 mils. thick. The scrim layer 1306 is black or opaque and is laminated with an opaque or colored adhesive layer 1308 to offer more protection against pinholes or other blemishes. Furthermore, the adhesive layer 1308 can overlay the top side of the scrim layer 1306 in addition to or alternatively to underlying the scrim layer 1306.

Additionally, an abrasion resistant film layer 1304 overlays the top side of the scrim layer 1306. The abrasion resistant film layer 1304 can be 0.1-5 mils. thick. The abrasion resistant film layer 1304 is a hard film such as Mylar®, HDPE, Tedlar®, acrylic or nylon. The abrasion resistant film layer 1304 acts to protect the scrim layer 1306 from abrasion and puncture which can occur during the course of handling, erecting, stretching and cleaning of the composite fabric 1300. The abrasion resistant film layer 1304 may also add chemical permeation protection to the composite fabric 1300. Furthermore, the abrasion resistant film layer 1304 may have an adhesive applied to it to bond the abrasion resistant layer 1304 to the scrim layer 1306, but the abrasion resistant layer 1304 does not need the adhesive and can be self-adhering.

Further, a top sheet thermoplastic layer 1302 overlays the abrasion resistant film layer 1304. The top sheet thermoplastic layer 1302 can be 2-20 mils. thick, and is typically a flexible PVC layer, but can be any thermoplastic or mixture of thermoplastics as listed supra. Furthermore, the top sheet thermoplastic layer 1302 can be colored, such as blue, green, etc. The composite fabric 1300 can also be constructed without the top sheet thermoplastic layer 1302.

Additionally, a second abrasion resistant film layer 1304 underlies the adhesive layer 1308. The abrasion resistant film layer 1304 can be 0.1-5 mils. thick and is a hard film such as Mylar®, HDPE, Tedlar®, acrylic or nylon. As stated supra, the abrasion resistant film layer 1304 does not need the adhesive layer 1308 and can be self-adhering.

Finally, a second or bottom sheet thermoplastic layer 1302 underlies the second abrasion resistant film layer 1304. The bottom sheet thermoplastic layer 1302 can be 2-20 mils. thick, and is typically a flexible PVC layer, but can be any thermoplastic or mixture of thermoplastics as listed supra. Furthermore, the flexible PVC layer 1302 can be colored, such as blue, green, etc. The composite fabric 1300 can also be constructed without the bottom sheet thermoplastic layer 1302.

Furthermore, a thermoplastic heat-sealable top or bottom coating can be applied to either side of the composite fabric embodiments as is readily known in the art without affecting the overall concept of the invention. Additionally, it is also contemplated that the above composite layers can be interchangeable without affecting the overall concept of the invention. Illustrative aspects are described herein in connection with the following description and the annexed drawings to further illustrate such interchangeability. These aspects are indicative, however, of but a few of the various ways in which the layers disclosed herein can be employed and interchanged, and the contemplated invention is intended to include all such aspects and their equivalents.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A composite fabric, comprising:
a scrim sheet having a first and a second side;
a top sheet thermoplastic layer overlaying the second side of the scrim sheet;
a thermoplastic layer underlying the first side of the scrim sheet, wherein an adhesive bonds the thermoplastic layer to the scrim sheet;
an abrasion resistant film layer underlying the thermoplastic layer; and
a bottom sheet thermoplastic layer underlying the abrasion resistant film layer.

2. The composite fabric of claim 1, further comprising an adhesive applied to both sides of the abrasion resistant film layer to bond the abrasion resistant film layer to the thermoplastic layers.

3. The composite fabric of claim 1, wherein the scrim sheet is combined with a plastisol adhesive as a set and then laminated with the adhesive layer.

4. The composite fabric of claim 1, wherein the scrim sheet is an opaque fabric.

5. The composite fabric of claim 4, wherein the adhesive layer bonding the thermoplastic layer to the scrim sheet is an opaque adhesive.

6. The composite fabric of claim 5, wherein the thermoplastic layer underlying the first side of the scrim sheet is an opaque polyvinyl chloride (PVC) layer.

7. The composite fabric of claim 6, wherein the top and bottom sheet thermoplastic layers are white, flexible PVC layers.

8. The composite fabric of claim 1, wherein all the thermoplastic layers are selected from the group comprising at least one of polyolefins, polyvinyl chloride (PVC), urethane, nylons, fluorocarbons, polyethylene, polypropylene, polyurethane prepolymer, polystyrene, high impact strength polystyrenes, cellulosic resins, acrylic resins, polyphenylene oxides or polyphenylene sulfide.

9. The composite fabric of claim 1, wherein the abrasion resistant film layer is selected from the group comprising at least one of Mylar®, Tedlar®, polyethylene terephthalate (PET), polyvinyl fluoride (PVF), polyvinylidene fluoride (PVDF), high-density polyethylene (HDPE), acrylic, or polyurethane.

10. The composite fabric of claim 1, wherein the adhesive layer is a plastisol.

11. The composite fabric of claim 1, wherein the top and bottom sheet thermoplastic layers have a thickness in a range of 2-20 mils.

12. The composite fabric of claim 1, wherein the scrim sheet has a thickness in a range of 0.5-10 oz.

13. The composite fabric of claim 1, wherein the adhesive layer has a thickness in a range of 0.1-5 mils.

14. The composite fabric of claim 1, wherein the thermoplastic layer has a thickness in a range of 1-5 mils.

15. The composite fabric of claim 1, wherein the adhesive layers adhered to the abrasion resistant film layer have a thickness in a range of 0.1-5 mils.

16. The composite fabric of claim 1, wherein the abrasion resistant film layer has a thickness in a range of 0.1-5 mils.

17. The composite fabric of claim 1, wherein the thermoplastic layer underlying the first side of the scrim sheet is removed from the composite fabric.

18. A multi-layer composite fabric construction, comprising:
a scrim sheet having a first and a second side;
a bottom sheet thermoplastic layer underlying the first side of the scrim sheet;
an opaque thermoplastic layer overlaying the second side of the scrim sheet, wherein an adhesive bonds the opaque thermoplastic layer to the scrim sheet;
an abrasion resistant film layer overlaying the opaque thermoplastic layer;
a top sheet thermoplastic layer overlaying the abrasion resistant film layer; and
a polyester adhesive applied to both sides of the abrasion resistant film layer to bond the abrasion resistant film layer to the top sheet thermoplastic layer and the opaque thermoplastic layer.

19. The multi-layer composite fabric of claim 18, further comprising:
a second opaque thermoplastic layer underlying the first side of the scrim sheet, wherein an adhesive bonds the second opaque thermoplastic layer to the scrim sheet;
a second abrasion resistant film layer underlying the second opaque thermoplastic layer, wherein the bottom sheet thermoplastic layer underlies the abrasion resistant film layer; and
an adhesive applied to both sides of the second abrasion resistant film layer to bond the second abrasion resistant film layer to the bottom sheet thermoplastic layer and the second opaque thermoplastic layer.

20. A multi-layer composite fabric construction comprising:
a scrim sheet having a first and a second side;
a top sheet thermoplastic layer overlaying the second side of the scrim sheet;
an opaque adhesive underlying the first side of the scrim sheet;
a first abrasion resistant film layer underlying the opaque adhesive layer, wherein a first polyester adhesive is applied to both sides of the abrasion resistant film layer;
an opaque thermoplastic layer underlying the first abrasion resistant film layer, wherein the first polyester adhesive bonds the first abrasion resistant film layer to the scrim sheet and the opaque thermoplastic layer;
a second abrasion resistant film layer underlying the opaque thermoplastic layer, wherein a second polyester adhesive is applied to both sides of the second abrasion resistant film layer; and
a bottom sheet thermoplastic layer underlying the second abrasion resistant film layer, wherein the second polyester adhesive bonds the second abrasion resistant film layer to the opaque thermoplastic layer and the bottom sheet thermoplastic layer.

21. A method of fabricating a composite fabric, comprising:
providing a scrim sheet having a first and a second side;
overlaying a top sheet thermoplastic layer on the second side of the scrim sheet;
overlaying an opaque thermoplastic layer on the first side of the scrim sheet;
utilizing an adhesive to bond the opaque thermoplastic layer to the scrim sheet;
positioning a Mylar® layer between the opaque thermoplastic layer and a bottom sheet thermoplastic layer;
overlaying the bottom sheet thermoplastic layer on the Mylar® layer; and
utilizing a polyester adhesive to bond the Mylar® layer to the opaque thermoplastic layer and the bottom sheet thermoplastic layer.

22. A multi-layer composite fabric construction comprising:
a scrim sheet having a first and a second side;
a first abrasion resistant film layer overlaying the second side of the scrim sheet;
a top sheet thermoplastic layer overlaying the first abrasion resistant film layer;
a second abrasion resistant film layer underlying the first side of the scrim sheet; and
a bottom sheet thermoplastic layer underlying the second abrasion resistant film layer.

23. The multi-layer composite fabric construction of claim 22, wherein the first and second abrasion resistant film layers are replaced with first and second ripstop cloth layers; and the scrim sheet is replaced with an opaque thermoplastic layer.

24. The multi-layer composite fabric construction of claim 22, further comprising an adhesive layer underlying the first side of the scrim sheet, and the second abrasion resistant film layer underlying the adhesive layer.

25. A composite fabric, comprising:
a scrim sheet having a first and a second side;
a top sheet thermoplastic layer overlaying the second side of the scrim sheet;
an opaque thermoplastic layer underlying the first side of the scrim sheet, wherein an adhesive bonds the opaque thermoplastic layer to the scrim sheet; and
a bottom sheet thermoplastic layer underlying the opaque thermoplastic layer.
